(19) United States
(12) Patent Application Publication
(10) Pub. No.: US 2018/0101814 A1
(43) Pub. Date: Apr. 12, 2018

(54) DYNAMIC SUPPLY CHAIN MANAGEMENT SYSTEMS AND METHODS

(71) Applicant: Wal-Mart Stores, Inc., Bentonville, AR (US)

(72) Inventors: Trinadh Nadella, Bentonville, AR (US); Ming Li, Centerton, AR (US); Mariana Pop, Bentonville, AR (US); Pranay K. Chavva, Rogers, AR (US); Xin Yang, Bellevue, WA (US)

(21) Appl. No.: 15/728,817

(22) Filed: Oct. 10, 2017

Related U.S. Application Data
(60) Provisional application No. 62/407,042, filed on Oct. 12, 2016.

(51) Int. Cl. G06Q 10/08; G06N 5/04

(52) U.S. Cl. CPC G06Q 10/087; G06N 5/04

(57) ABSTRACT

Embodiments relate to dynamic supply chain management systems and methods. The systems and methods can compile and decompose historical order data to identify causality factors that produced variability in historical order lead times or fill rates. These factors then can be applied to current orders to determine dynamic order lead time and dynamic order fill rate, and a characteristic of the order can be adjusted to provide more accuracy and reduced variability in the supply chain.

### RELATED APPLICATION

The present application claims the benefit of U.S. Provisional Application No. 62/407,042 filed Oct. 12, 2016, which is hereby incorporated herein in its entirety by reference.

### TECHNICAL FIELD

Embodiments relate generally to supply chain logistics and more particularly to supply chain management by dynamic fill rate and lead rate determination using source decomposition.

### BACKGROUND

Conventional supply chain management systems use a relative static lead time, must arrive by date (MABD), and fill rate for most suppliers in the order/replenish system. For a variety of reasons, there is significant variability in both lead time and fill rate. Failure to consider this variability can lead to supply chain inefficiency and a lack of products at the right place when needed. This variability is determined by many factors, however, making it complex and outside the scope or capabilities of conventional supply chain management systems.

### SUMMARY

In an embodiment, a dynamic supply chain management system comprises a historical causality database comprising historical data related to external factors that affected a supply chain; a historical order information database comprising historical data related to order information in the supply chain; a current causality database comprising current or predicted data related to external factors affecting the supply chain; a current order information database comprising order data related to a current order in the supply chain; a supply chain management engine communicatively coupled with the historical causality database, the historical order information database, the current causality database, and the current order information database and configured to: decompose the historical data related to external factors that affected a supply chain and the historical data related to order information in the supply chain to determine a plurality of factors, each of the plurality of factors having affected at least one of historical lead time and historical fill rate variability, determine a current order lead time and a current order fill rate from the current or predicted data from the current causality database and the order data from the current order information database, and apply an algorithm based on the plurality of factors to the determined current order lead time and current order fill rate to determine a dynamic order lead time and a dynamic order fill rate variability for the current order.

In an embodiment, a dynamic supply chain management method comprises compiling historical data related to external factors that affected a supply chain and historical data related to order information in the supply chain; decomposing the historical data related to external factors that affected a supply chain and the historical data related to order information in the supply chain to determine a plurality of factors, each of the plurality of factors having affected at least one of historical lead time and historical fill rate variability; obtaining data about a current order in the supply chain and determining a current order lead time and a current order fill rate for a current order; and applying an algorithm based on the plurality of factors to the determined current order lead time and current order fill rate to determine a dynamic order lead time and a dynamic order fill rate variability for the current order.

### BRIEF DESCRIPTION OF THE DRAWINGS

Embodiments may be more completely understood in consideration of the following detailed description of various embodiments in connection with the accompanying drawings, in which:

FIG. 1 is a block diagram of a dynamic supply chain management system according to an embodiment.

FIG. 2 is a blended functional/structural diagram of a dynamic supply chain management system according to an embodiment.

FIG. 3 is a flowchart of a method of dynamic supply chain management according to an embodiment.

### DETAILED DESCRIPTION

A supply chain is a sequence of processes and events involved in the production and distribution of a product. A supply chain can include structures, equipment, raw materials, parts, components, organizations, people, locations, modes and means of transit, activities, information and other resources involved in producing a product and moving the product from a manufacturer or supplier to a customer. A variety of factors can affect or influence the supply chain at a variety of different points and times, and these factors can be unpredictable. A supply chain management system can endeavor to identify, influence and otherwise manage these factors such that the supply chain can operate as efficiently and effectively as possible.

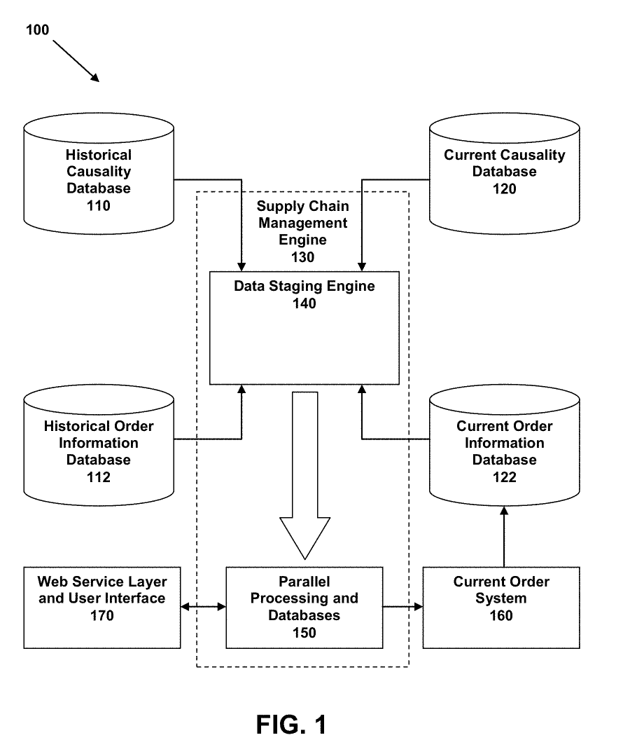

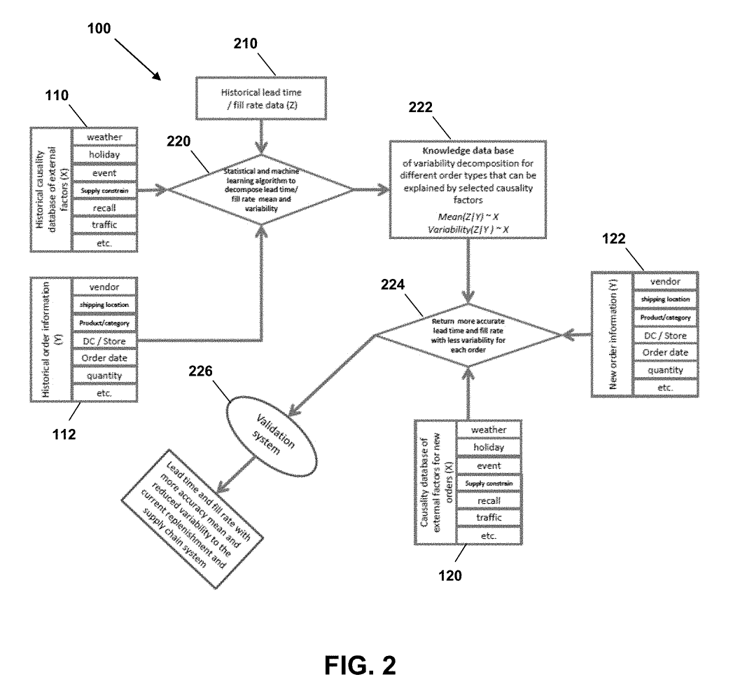

Referring to FIGS. 1 and 2, an embodiment of a dynamic supply chain management system 100 is depicted. System 100 comprises two historical information databases, historical causality database 110 and historical order information database 112; two current information databases: current causality database 120 and current order information database 122; a supply chain management engine 130 comprising a data staging environment 140 and parallel processing hardware and databases 150; a current order information database 160; and a web service layer and user interface 170. In other embodiments, one or both of web service layer user interface 170 and current order system 160 can be part of supply chain management engine 130. Additional communicative couplings not specifically depicted (e.g., between web service layer user interface 170 and current order system 160) also can exist.

System 100 and/or its components or subsystems can include computing devices, microprocessors, modules and other computer or computing devices, which can be any programmable device that accepts digital data as input, is configured to process the input according to instructions or algorithms, and provides results as outputs. In an embodiment, computing and other such devices discussed herein can be, comprise, contain or be coupled to a central processing unit (CPU) configured to carry out the instructions of a computer program. Computing and other such devices discussed herein are therefore configured to perform basic arithmetical, logical, and input/output operations.

Computing and other devices discussed herein can include memory. Memory can comprise volatile or non-volatile memory as required by the coupled computing device or processor to not only provide space to execute the instructions or algorithms, but to provide the space to store the instructions themselves. In embodiments, volatile memory can include random access memory (RAM), dynamic random access memory (DRAM), or static random access memory (SRAM), for example. In embodiments, non-volatile memory can include read-only memory, flash memory, ferroelectric RAM, hard disk, floppy disk, magnetic tape, or optical disc storage, for example. The foregoing lists in no way limit the type of memory that can be used, as these embodiments are given only by way of example and are not intended to limit the scope of the disclosure.

In embodiments, the system or components thereof can comprise or include various modules or engines, each of which is constructed, programmed, configured, or otherwise adapted to autonomously carry out a function or set of functions. The term “engine” as used herein is defined as a real-world device, component, or arrangement of components implemented using hardware, such as by an application specific integrated circuit (ASIC) or field programmable gate array (FPGA), for example, or as a combination of hardware and software, such as by a microprocessor system and a set of program instructions that adapt the engine to implement the particular functionality, which (while being executed) transform the microprocessor system into a special-purpose device. An engine can also be implemented as a combination of the two, with certain functions facilitated by hardware alone, and other functions facilitated by a combination of hardware and software. In certain implementations, at least a portion, and in some cases, all, of an engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each engine can be realized in a variety of physically realizable configurations, and should generally not be limited to any particular implementation exemplified herein, unless such limitations are expressly called out. In addition, an engine can itself be composed of more than one sub-engines, each of which can be regarded as an engine in its own right. Moreover, in the embodiments described herein, each of the various engines corresponds to a defined autonomous functionality; however, it should be understood that in other contemplated embodiments, each functionality can be distributed to more than one engine. Likewise, in other contemplated embodiments, multiple defined functionalities may be implemented by a single engine that performs those multiple functions, possibly alongside other functions, or distributed differently among a set of engines than specifically illustrated in the examples herein.

Historical causality database 110, historical order information database 112, current causality database 120 and current order information database 122 each comprise database hardware and software configured to store data and communicate related to the data (e.g., receive the data from other system components, and send the data to other system components). Though each is depicted as a single entity, databases 110, 112, 120 and 122 can comprise multiple database modules or devices, including modules or devices that are physically separate from one other. In some embodiments, one or more of databases 110, 112, 120 and 122 can share hardware or software. One or more of databases 110, 112, 120 and 122 can be co-networked or communicatively coupled with the same network.

As used throughout this disclosure, a database is a structured set of data held in a computer. Database software provides functionalities that allow building, modifying, accessing, and updating both databases and the underlying data. Databases and database software reside on database servers. Database servers are collections of hardware and software that provide storage and access to the database and enable execution of the database software. Many databases and database systems, including those of dynamic supply chain management system 100, support the analysis of large data sets in order to meet business, research, or other needs. These large data sets are often colloquially known as “big data.” Many database systems, tools, and techniques have been developed to better handle big data.

Databases 110, 112, 120 and 122 can be relational databases with tabular structures, or NoSQL or other non-relational databases with key-value, grid, or other structures. One or more of databases 110, 112, 120 and 122 provide storage for one or more data items. In embodiments, data items can include individual cells or fields, rows, tables, key-value pairs, or entire databases. In embodiments, the stored data items can be divided into groups based on criteria such as the values of subcomponents of each data item. Each stored data item can be held in one or more containers within databases 110, 112, 120 and 122.

In an example embodiment, the containers of any of databases 110, 112, 120 and 122 can be one or more tables, each table having a set of defined columns, and each data item can comprise a single row a table which can include cells which contain values corresponding to the defined columns. In such an embodiment, the data items could then be grouped based on the value of the cells in a given column.

Historical causality database 110 comprises historical data related to external factors that affected a supply chain. Historical causality data can comprise weather or natural disaster information, unexpected or disruptive event information, holiday information, supply availability information, product recall information, traffic and/or construction information, fleet or maintenance information, or other data related to external factors that historically affected a supply chain in one way or another. The data can comprise information about the nature and impact of the factor. For example, historical causality database 110 can store information related to an ice storm that caused a power outage at a supplier resulting in a two-day delay in shipping a product.

Historical order information database 112 comprises historical data related to order information in the supply chain. This data can comprise vendor, production and/or shipping location, distribution center, store or delivery location, product category, products ordered, quantities ordered, date ordered, date delivered, prices of products ordered, and other information related to actual orders placed and handled by system 100, a predecessor system, or another supply chain management system. For example, historical order information database 112 can store information about an order placed on Jun. 1, 2010, for 100 men's t-shirts from ABC Shirt Company, size large, color gray, price $3.00 each, delivered on Jun. 15, 2010.

Current causality database 120 comprises current or predicted data related to external factors affecting the supply chain and one or more current orders. The type of data and information in current causality database 120 can be similar to that of historical causality database 110 except that it is current or forward-looking as opposed to historical or backward-looking.

Current order information database 122 comprises order data related to a current order in the supply chain. The type of data and information in current order information database 122 can be similar to that of historical order information database 112 except that it relates to current or open orders as opposed to historical or completed orders.

Each of databases 110, 112, 120 and 122 is communicatively coupled with data staging engine 140 of supply chain management engine 130. In an embodiment, data staging engine 140 comprises a distributed environment utilizing Hadoop/Hive or some other suitable data warehouse infrastructure and processing/analysis tool. Data staging engine 140 receives data and information from historical causality database 110 and a historical order information database 112 and merges the data. The data can be provided in a variety of forms, such as flat file, data stream, internal or external format, character format, indicator format, graphic format, merged format, or other data formats. In some embodiments, the different data formats can be provided by different ones of databases 110, 112, 120 and 122 or for different types within any one of databases 110, 112, 120 and 122. The distributed environment of data staging engine 140 enables statistical and machine learning algorithms and techniques (such as ANOVA, regression, variable selections, classification, clustering, association, causal inference, and/or combinations of these and other techniques) to be applied to the data in parallel. As a result, historical order lead time (i.e., the time from initiation to completion of an order) and historical order fill rate (i.e., a measure of the percentage of fulfillment of each order) can be determined with variability estimation. Other historical measures also can be determined.

In some embodiments, aggregated determined historical lead time and fill rate data can be stored in a historical data database 210. Because of the huge volumes of historical data that can be implicated in these analyses, storing aggregated data can make this data available for further use by system 100 as well as for scheduled or periodic updating. For example, five years of historical data can be analyzed and stored in database 210, and then this data can be updated (e.g., daily, weekly, monthly, quarterly, etc.) as new historical data becomes available with the passage of time.

Once determined, variability in the historical order lead time, order fill rate, and other measures can be identified and decomposed by application of a statistical and machine learning algorithm by data staging engine 140, such as at 220 in FIG. 2. In one embodiment, the historical measures can be decomposed with respect to external factors that affected a supply chain and the historical data related to order information in the supply chain, in order to determine one or a plurality of factors that, in historical actuality, affected supply chain efficiency or effectiveness. Decomposition can involve using models to explain variability that then can be applied to new data to achieve dynamic lead time and dynamic fill rates. Decomposition techniques can be useful in the parallel processing of large amounts of data, which can be the case in system 100 in which a high number of historical orders may be available and a high number of current orders may be processed. The result of decomposition can be identification of particular factors of impact or influence on different types of orders that can be explained by selected causality factors. This data can be stored in one or more knowledge database(s) 222. The knowledge database(s) contain raw data and processed knowledge. For example, snow fall amount is raw data, and based on different locations the relative significance of snow fall amount is calculated and stored in the knowledge database(s) with leading and lagging effects. Interaction effects among different events can be realized partially in the knowledge database(s) and partially from the statistical and machine learning algorithms. These then can be applied by system 100 to current orders with predicted events that may impact the supply chain of those orders to better and more effectively manage current orders.

At the same time in some embodiments, current causality database 120 and current order information database 122 stream data and information related to current orders to data staging engine 140. As for historical causality database 110 and historical order information database 112, the data can be provided in a variety of different forms, as discussed above. From this data and by also applying the decomposed historical order lead time and order fill rate at 224, data staging engine 140 can determine a dynamic current order lead time and a dynamic current order fill rate for a particular current order. In some embodiments, the dynamic current order lead time and the dynamic current order fill rate for each of a plurality of orders can be aggregated, though in general individual order-specific lead time and fill rate data is desired.

The determined dynamic current order lead time and dynamic current order fill rate for a particular current order then can be communicated from data staging engine 140 to parallel processing and databases 150. Parallel processing and databases 150 can make a final validation/determination, or request approval, at 226 regarding whether to apply the determined dynamic current order lead time and dynamic current order fill rate to the current order.

For example, the determined dynamic current order fill rate may necessitate adjusting an order date and/or order quantity (e.g., because of a production facility's capacity). Parallel processing and databases 150 can include a set of predefined rules that define when supply chain management engine 130 may automatically make an adjustment and when supply chain management engine 130 must seek human approval via web service layer and user interface 170 for any adjustment. In this example, the rules may permit supply chain management engine 130 to automatically adjust an order date by up to seven days. If the determined dynamic current order fill rate would require an adjustment of fifteen days, supply chain management engine 130 would seek approval by issuing a prompt via web service layer and user interface 170.

In embodiments, machine learning and algorithms also can be applied to the rules used by parallel processing and databases 150 in order to refine and improve the rules themselves. For example, if supply chain management engine 130 tracks and determines that every requested manual approval of order dates less than twenty-one days is approved, supply chain management engine 130 can suggest for approval that the automatic adjustment threshold be increased from seven days to twenty-one days. In general, it is desired to minimize requests for manual approval such that they are sought only in very special exception situations.

In embodiments, parallel processing and databases 150 is communicatively coupled with current order system 160 to provide raw aggregated lead time and fill rate variability data (which typically is much larger than the decomposed variability) to current order system 160. This data can in turn be provided to current order information database 122 along with the output or result from parallel processing and databases 150 (when approved, if necessary, via web service layer and user interface 170) for a particular order such that current order system 160 can then place the order, which should have reduced variability as a result of the decomposed data and applied dynamic current order lead time and dynamic current order fill rate.

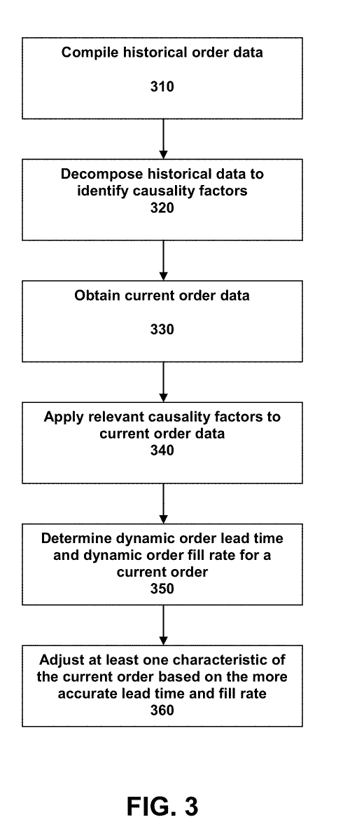

Therefore, and referring to FIG. 3, in one embodiment system 100 compiles historical order data at 310. This data can be complex and voluminous (e.g., covering thousands of orders over many years or decades), such that this task is outside human capabilities and still may take significant amounts of time to assemble and process. Access to some amount of historical data is important, and more data can improve the accuracy and abilities of system 100.

At 320, the compiled historical data is decomposed to identify causality factors. These are factors, whether internal or external, that influenced past orders and can be associated with some form or amount of variability such that the factors can be applied to similar current or future orders. For example, weather influenced orders placed from a particular supplier during a particular time of year.

At 330, data for at least one current order is obtained, and at 340 relevant causality factors can be applied to the current order data. This can determine a dynamic order lead time and a dynamic order fill rate for the current order at 350.

At 360, at least one characteristic of the current order (e.g., order date, shipping modality, quantity, etc.) can be adjusted based on the determined dynamic order lead time and dynamic order fill rate to provide more accuracy and reduced variability in the supply chain.

Various embodiments of systems, devices, and methods have been described herein. These embodiments are given only by way of example and are not intended to limit the scope of the invention. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the invention.

Persons of ordinary skill in the relevant arts will recognize that the invention may comprise fewer features than illustrated in any individual embodiment described above. The embodiments described herein are not meant to be an exhaustive presentation of the ways in which the various features of the invention may be combined. Accordingly, the embodiments are not mutually exclusive combinations of features; rather, the invention may comprise a combination of different individual features selected from different individual embodiments, as understood by persons of ordinary skill in the art.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims for the present invention, it is expressly intended that the provisions of Section 112, sixth paragraph of 35 U.S.C. are not to be invoked unless the specific terms “means for” or “step for” are recited in a claim.

1. A dynamic supply chain management system comprising:
a historical causality database comprising historical data related to external factors that affected a supply chain;
a historical order information database comprising historical data related to order information in the supply chain;
a current causality database comprising current or predicted data related to external factors affecting the supply chain;
a current order information database comprising order data related to a current order in the supply chain;
a supply chain management engine communicatively coupled with the historical causality database, the historical order information database, the current causality database, and the current order information database and configured to:
decompose the historical data related to external factors that affected a supply chain and the historical data related to order information in the supply chain to determine a plurality of factors, each of the plurality of factors having affected at least one of historical lead time and historical fill rate variability,
determine a current order lead time and a current order fill rate from the current or predicted data from the current causality database and the order data from the current order information database, and
apply an algorithm based on the plurality of factors to the determined current order lead time and current order fill rate to determine a dynamic order lead time and a dynamic order fill rate variability for the current order.

2. The system of claim 1, further comprising an order system communicatively coupled with the current order information database to provide the order data

3. The system of claim 2, wherein the order system is configured to apply the dynamic order lead time and the dynamic order fill rate variability to the current order.

4. The system of claim 3, wherein the order system is configured to change at least one characteristic of the current order based on the applied dynamic lead time and dynamic order fill rate variability.

5. The system of claim 4, wherein the at least one characteristic is at least one of an order date, an order quantity, a vendor, a distribution center, a mode of transport, a transport carrier, or an order destination.

6. The system of claim 4, wherein the supply chain management engine is configured to request authorization to make the change to at least one characteristic of the current order before entering the change.

7. The system of claim 2, wherein the supply chain management engine is configured to determine a raw aggregated lead time and a raw aggregated fill rate variability from the historical data related to external factors that affected a supply chain and the historical data related to order information in the supply chain, wherein the order system is configured to apply the raw aggregated lead time and the raw aggregated fill rate variability to the current order.

8. The system of claim 7, wherein the order system is configured to change at least one characteristic of the current order based on the applied raw aggregated lead time and raw aggregated fill rate variability.

9. The system of claim 8, wherein the at least one characteristic is at least one of an order date, an order quantity, a vendor, a distribution center, a mode of transport, a transport carrier, or an order destination.

10. The system of claim 1, further comprising a user interface communicatively coupled with the supply chain management engine and configured to present information about orders in which approval of circumstances related to the dynamic order lead time and the dynamic order fill rate is necessary.

11. The system of claim 10, wherein the user interface is configured to accept an approval or a disapproval in response to the presented information.

12. The system of claim 1, wherein the external factors relate to at least one of weather, holiday, mode of transport, transport carrier, event occurrence, or supply.

13. The system of claim 1, wherein the order information and the order relate to at least one of a day on which an order is placed, a season in which an order is placed, a month in which the order is placed, an order quantity, a product category, a distribution center, a destination, a vendor, a or production rate capability.

14. A dynamic supply chain management method comprising:
compiling historical data related to external factors that affected a supply chain and historical data related to order information in the supply chain;
decomposing the historical data related to external factors that affected a supply chain and the historical data related to order information in the supply chain to determine a plurality of factors, each of the plurality of factors having affected at least one of historical lead time and historical fill rate variability;
obtaining data about a current order in the supply chain and determining a current order lead time and a current order fill rate for a current order; and
applying an algorithm based on the plurality of factors to the determined current order lead time and current order fill rate to determine a dynamic order lead time and a dynamic order fill rate variability for the current order.

15. The method of claim 14, further comprising applying the dynamic order lead time and the dynamic order fill rate variability to the current order.

16. The method of claim 15, further comprising changing at least one characteristic of the current order based on the applied dynamic lead time and dynamic order fill rate variability.

17. The method of claim 16, further comprising presenting, via a user interface, information about the changing before implementing the changing to obtain advance approval.

18. The method of claim 14, further comprising:
determining a raw aggregated lead time and a raw aggregated fill rate variability from the historical data related to external factors that affected a supply chain and the historical data related to order information in the supply chain; and
applying the raw aggregated lead time and the raw aggregated fill rate variability to the current order.

19. The method of claim 18, further comprising changing at least one characteristic of the current order based on the applied raw aggregated lead time and raw aggregated fill rate variability.

20. The method of claim 19, further comprising presenting, via a user interface, information about the changing before implementing the changing to obtain advance approval.

21. The method of claim 14, further comprising presenting, via a user interface, information about orders in which approval of circumstances related to the dynamic order lead time and the dynamic order fill rate is necessary.

22. The method of claim 21, further comprising accepting, via the user interface, an approval or a disapproval in response to the presenting.
